(19) United States
(12) Patent Application Publication
(10) Pub. No.: US 2023/0087521 A1
(43) Pub. Date: Mar. 23, 2023

(54) COMPUTING DEVICE VERIFICATION

(71) Applicant: Ford Global Technologies, LLC, Dearborn, MI (US)

(72) Inventors: Ali Hassani, Ann Arbor, MI (US); Mackenzie Martinez, Commerce Twp., MI (US)

(73) Assignee: Ford Global Technologies, LLC, Dearborn, MI (US)

(21) Appl. No.: 17/479,231

(22) Filed: Sep. 20, 2021

(51) Int. Cl. H04L 9/32; H04L 9/08

(52) U.S. Cl. CPC H04L 9/3271; H04L 9/3242; H04L 9/0825; H04L 9/085

(57) ABSTRACT

In response to a trigger event, a challenge message that includes a security code by inputting the security code to a cryptographic program that encrypts the security code based on an authentication key is generated by a first computer. Upon transmitting the challenge message to a second computer, the security code is updated by the first computer based on a random number output from a random number generator. A response is received by the first computer from the second computer in response to the challenge message. Upon verifying the second computer based on the response, a security message including the updated security code is transmitted from the first computer to the second computer.

### BACKGROUND

Vehicles can be equipped with computers, networks, sensors, and/or controllers to acquire data regarding the vehicle's environment and/or to operate vehicle components. Vehicle sensors can provide data about a vehicle's environment, e.g., concerning routes to be traveled and objects in the vehicle's environment to be avoided. Various computing devices or controllers such as electronic control units (ECUs) can be provided in a vehicle and can communicate via a vehicle network. Messages sent and received via the vehicle network can relate to operating the vehicle, and can include sensor data, actuation commands, fault reports, etc. A vehicle computing device can operate a vehicle and make real-time decisions based on data received from sensors and/or computing devices.

### BRIEF DESCRIPTION OF THE DRAWINGS

FIG. 1 is a block diagram for an example control system for a vehicle.

FIG. 2A is a block diagram illustrating an example authentication message.

FIG. 2B is a block diagram illustrating an example challenge message.

FIG. 2C is a block diagram illustrating an example permutation program.

FIG. 2D is a block diagram illustrating an example security message.

FIG. 2E is a block diagram illustrating an example request message.

FIG. 2F is a block diagram illustrating an example response message.

FIG. 2G is a block diagram illustrating an example reply message.

FIG. 2H is a block diagram illustrating an example relay message.

FIG. 3 is a flowchart of an example process for updating a security code for a second computer.

FIG. 4 is a flowchart of an example process for updating the security code in a second computer.

### DETAILED DESCRIPTION

As disclosed herein, it is possible to reduce risk that a vehicle computer will send, receive, and/or act on inauthentic (or not authentic) data, i.e., false or unauthorized data. In the context of this document, inauthentic data is data injected into the vehicle communication network by an unauthorized source (i.e., a source other than one of the vehicle sensors or other authorized computing devices on a vehicle communication network). For example, during vehicle operations, data captured by sensors are included in messages received by the vehicle computer. Based on the sensor data, the vehicle computer can generate control signals to vehicle components that carry out vehicle operations. Difficulties can arise, however, if the data provided to the vehicle computer are not authentic. An example of inauthentic data may include data presented to the vehicle computer via an injection attack. An injection attack occurs when inauthentic data (e.g., data that is different from the data detected by the vehicle sensors) are maliciously uploaded to the vehicle communication network.

To authenticate data, a vehicle computer may input the data into a cryptographic program that encrypts the data based on a key. The vehicle computer may then provide messages including the encrypted data to various other computing devices, e.g., electronic control units (ECUs). Upon receiving a message including encrypted data, each ECU may input the encrypted data into the cryptographic program that decrypts the encrypted data based on the key. Encoding and decoding data to authenticate each message via a cryptographic program consumes computational resources, which may increase a power draw from a vehicle battery and may delay completion of various other operations due to the limited computational resources available in the vehicle.

Advantageously, a first computer may verify a second computer in response to a trigger event. Upon verifying the second computer, the first computer can provide an updated security code to the second computer. The updated security code may be used to authentic messages between the first and second computers. Updating the security code after detecting a trigger event can increase the entropy of the messages, which can reduce a likelihood of an unauthorized source guessing the security code and providing spoofed data to the computers. Additionally, verifying the second computer in response to a trigger event and using the updated security code to authenticate messages between computers reduces the computational load required to authenticate data transferred between the computers, which may decrease the power draw from the vehicle battery and/or may make computational resources available to perform various other operations.

A system includes a first computer including a processor and a memory, the memory storing instructions executable by the processor such that the first computer is programmed to, in response to a trigger event, generate a challenge message that includes a security code by inputting the security code to a cryptographic program that encrypts the security code based on an authentication key. The first computer is further programmed to, upon transmitting the challenge message to a second computer, update the security code based on a random number output from a random number generator. The first computer is further programmed to receive a reply message from the second computer in response to the challenge message. The first computer is further programmed to, upon verifying the second computer based on the reply message, transmit a security message including the updated security code to the second computer.

The first computer may be further programmed to generate the security message by inputting the updated security code to a cryptographic program that encrypts the security code based on a second authentication key.

The system may include the second computer, including a second processor and a second memory storing instructions executable by the second processor such that the second computer is programmed to input the encrypted updated security code to a cryptographic program that decrypts the encrypted updated security code based on the second authentication key.

The system may include the second computer, including a second processor and a second memory storing instructions executable by the second processor such that the second computer is programmed to input the encrypted security code to a cryptographic program that decrypts the encrypted security code based on the authentication key. The second computer may be further programmed to transmit the reply message including the security code in response to the challenge message.

The system may include the second computer, including a second processor and a second memory storing instructions executable by the second processor such that the second computer is programmed to, upon receiving the challenge message, verify the first computer based on the security code matching a stored security code. The second computer may be further programmed to then transmit the reply message including the stored security code.

The first computer may be further programmed to, upon receiving the reply message, verify the second computer based on the stored security code matching the security code.

The first computer may be further programmed to, prior to detecting a second trigger event, transmit a request message to the second computer including the updated security code and a counter. The first computer may be further programmed to then increment the counter stored in a respective memory.

The first computer may be further programmed to authenticate a relay message from the second computer based on the relay message including the updated security code and the incremented counter in response to the request message.

The system may include the second computer, including a second processor and a second memory storing instructions executable by the second processor such that the second computer is programmed to authenticate the request message from the first computer based on the request message including the updated security code and the counter. The second computer may be further programmed to increment the counter stored in a respective memory. The second computer may be further programmed to transmit a relay message including the updated security code and the incremented counter.

The system may include the second computer, including a second processor and a second memory storing instructions executable by the second processor such that the second computer is programmed to update a stored security code in response to the security message.

The trigger event may be determined based on a power draw from a vehicle battery being below a threshold.

The trigger event may be expiration of a timer.

The first computer and the second computer may be included in a vehicle.

The first computer may be remote from a vehicle and the second computer may be included in the vehicle.

A method includes, in response to a trigger event, generating, at a first computer, a challenge message that includes a security code by inputting the security code to a cryptographic program that encrypts the security code based on an authentication key. The method further includes, upon transmitting the challenge message to a second computer, updating the security code based on a random number output from a random number generator. The method further includes receiving a reply message from the second computer in response to the challenge message. The method further includes, upon verifying the second computer based on the response, transmitting a security message including the updated security code to the second computer.

The method can further include generating the security message by inputting the updated security code to a cryptographic program that encrypts the security code based on a second authentication key.

The method can further include, prior to detecting a second trigger event, transmitting a request message to the second computer including the updated security code and a counter. The method can further include then incrementing the counter stored in a respective memory.

The method can further include authenticating a relay message from the second computer based on the relay message including the updated security code and the incremented counter in response to the request message.

The trigger event may be determined based on a power draw from a vehicle battery being below a threshold.

The trigger event may be expiration of a timer.

Further disclosed herein is a computing device programmed to execute any of the above method steps. Yet further disclosed herein is a computer program product, including a computer readable medium storing instructions executable by a computer processor, to execute an of the above method steps

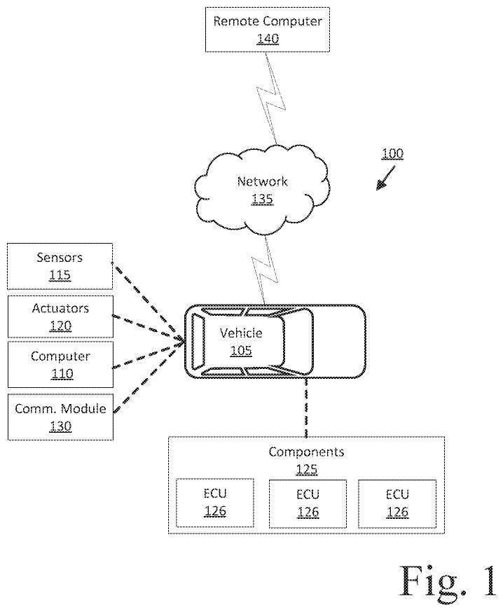

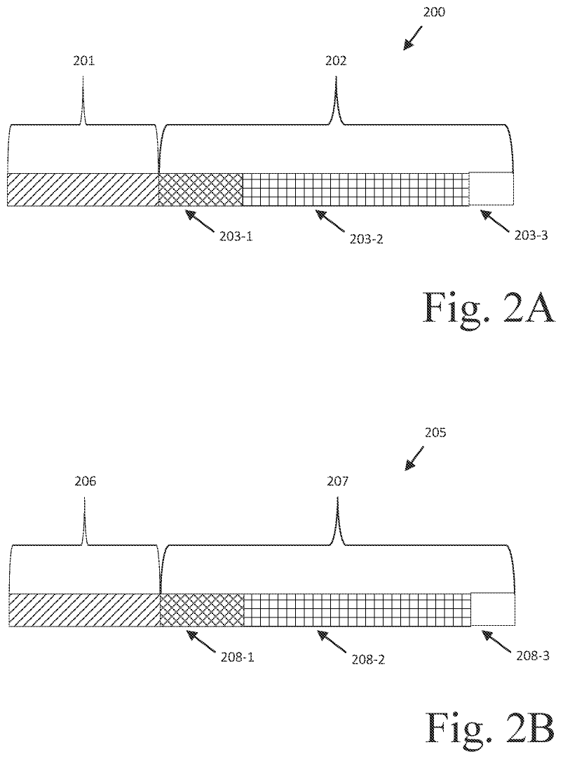

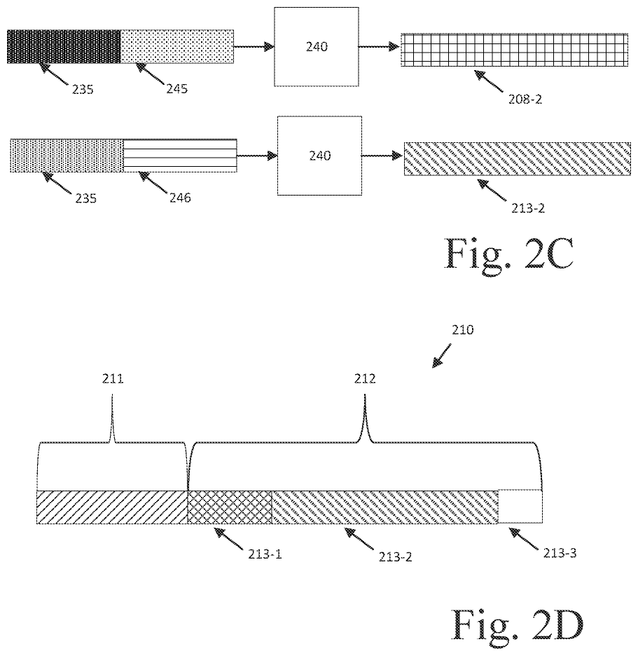

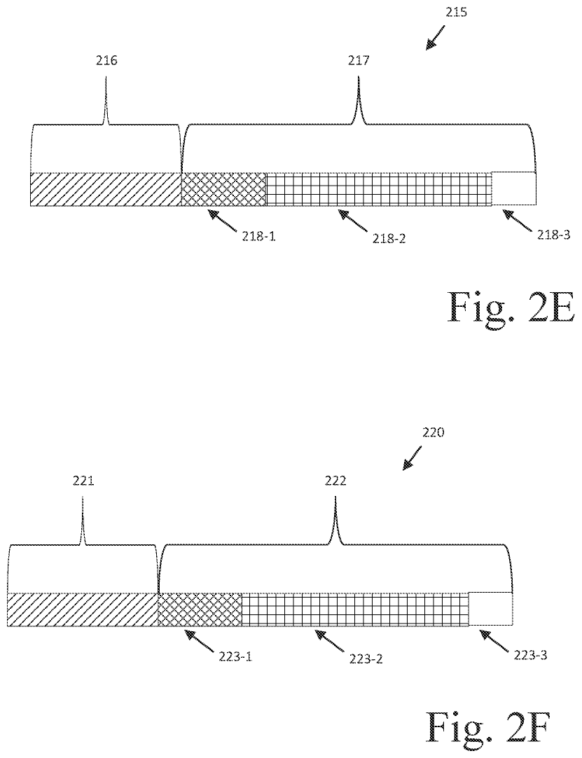

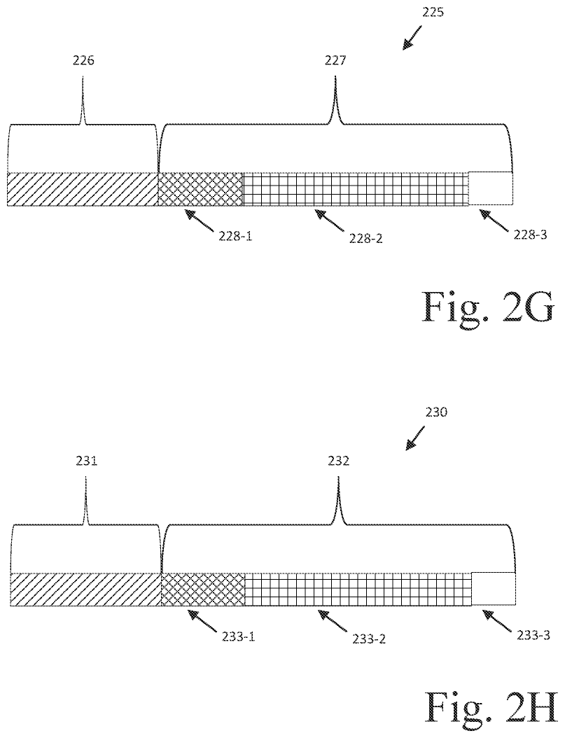

With reference to FIGS. 1-2H, an example control system 100 includes a vehicle 105. A computer 110 in the vehicle 105 receives data from sensors 115. The computer 110 is programmed to, in response to a trigger event, generate a challenge message 205 that includes a security code 235 by inputting the security code 235 to a cryptographic program that encrypts the security code 235 based on an authentication key 245. The computer 110 is further programmed to, upon transmitting the challenge message 205 to an electronic control unit (ECU) 126, update the security code 235 based on a random number output from a random number generator. The computer 110 is further programmed to receive a reply message 225 from the ECU 126 in response to the challenge message 205. The computer 110 is further programmed to, upon verifying the ECU 126 based on the reply message 225, transmit a security message 210 including the updated security code 235 to the ECU 126.

Turning now to FIG. 1, the vehicle 105 typically includes the computer 110, sensors 115, actuators 120 to actuate various vehicle components, and a vehicle communications module 130. The communications module 130 allows the computer 110 to communicate with a remote computer 140, and/or other vehicles, e.g., via a messaging or broadcast protocol such as Dedicated Short Range Communications (DSRC), Ultra-Wideband (UWB), cellular, and/or other protocol that can support vehicle-to-vehicle, vehicle-to infrastructure, vehicle-to-cloud communications, or the like, and/or via a packet network 135.

The computer 110 includes a processor and a memory such as are known. The memory includes one or more forms of computer-readable media, and stores instructions executable by the computer 110 for performing various operations, including as disclosed herein. The computer 110 can further include two or more computing devices operating in concert to carry out vehicle 105 operations including as described herein. Further, the computer 110 can be a generic computer with a processor and memory as described above, and/or may include an ECU 126 or electronic controller or the like for a specific function or set of functions, and/or may include a dedicated electronic circuit including an ASIC that is manufactured for a particular operation, e.g., an ASIC for processing sensor 115 data and/or communicating the sensor 115 data. In another example, the computer 110 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in the computer 110.

The computer 110 may operate and/or monitor the vehicle 105 in an autonomous mode, a semi-autonomous mode, or a non-autonomous (or manual) mode, i.e., can control and/or monitor operation of the vehicle 105, including controlling and/or monitoring components 125. For purposes of this disclosure, an autonomous mode is defined as one in which each of vehicle 105 propulsion, braking, and steering are controlled by the computer 110; in a semi-autonomous mode the computer 110 control one or two of vehicle 105 propulsion, braking, and steering; in a non-autonomous mode a human operator controls each of vehicle 105 propulsion, braking, and steering.

The computer 110 may include programming to operate one or more of vehicle 105 brakes, propulsion (e.g., control of acceleration in the vehicle 105 by controlling one or more of an internal combustion engine, electric motor, hybrid engine, etc.), steering, transmission, climate control, interior and/or exterior lights, horn, doors, etc., as well as to determine whether and when the computer 110, as opposed to a human operator, is to control such operations.

The computer 110 may include or be communicatively coupled to, e.g., via a vehicle communications network such as a communications bus as described further below, more than one processor, e.g., included in ECUs 126 or the like included in the vehicle 105 for monitoring and/or controlling various vehicle components, e.g., a transmission controller, a brake controller, a steering controller, etc. The computer 110 is generally arranged for communications on a vehicle communication network that can include a bus in the vehicle 105 such as a controller area network (CAN) or the like, and/or other wired and/or wireless mechanisms.

Via the vehicle communication network, the computer 110 may transmit messages to various devices in the vehicle 105 and/or receive messages (e.g., CAN messages) from the various devices, e.g., sensors 115, an actuator 120, ECUs 126, other computers, etc. Alternatively, or additionally, in cases where the computer 110 actually comprises a plurality of devices, the vehicle communication network may be used for communications between devices represented as the computer 110 in this disclosure. Further, as mentioned below, various controllers and/or sensors 115 may provide data to the computer 110 via the vehicle communication network.

Vehicle 105 sensors 115 may include a variety of devices such as are known, e.g., Light Detection And Ranging (LIDAR) sensor 115(s), radar sensors 115, camera sensors 115, etc. to provide data to the computer 110.

The vehicle 105 actuators 120 are implemented via circuits, chips, or other electronic and or mechanical components that can actuate various vehicle 105 subsystems in accordance with appropriate control signals as is known. The actuators 120 may be used to control components 125, including braking, acceleration, and steering of a vehicle 105.

In the context of the present disclosure, a vehicle 105 component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a suspension component (e.g., that may include one or more of a damper, e.g., a shock or a strut, a bushing, a spring, a control arm, a ball joint, a linkage, etc.), a brake component, a park assist component, an adaptive cruise control component, an adaptive steering component, one or more passive restraint systems (e.g., airbags), a movable seat, etc.

The vehicle 105 can include a plurality of ECUs 126 that are communicatively coupled via a network, typically on a vehicle communications bus or network. The ECUs 126 can be conventional computing devices, i.e., including one or more processors and one or more memories, programmed to provide operations such as disclosed herein. For example, an ECU 126 can be programmed to monitor and/or control one or more vehicle components. The ECUs 126 can be accessed via the vehicle communication network.

In addition, the computer 110 may be configured for communicating via a vehicle-to-vehicle communication module 130 or interface with devices outside of the vehicle 105, e.g., through a vehicle-to-vehicle (V2V) or vehicle-to-infrastructure (V2X) wireless communications (cellular and/or short-range radio communications, etc.) to another vehicle, and/or to a remote computer 140 (typically via direct radio frequency communications). The communications module 130 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module include cellular, Bluetooth, IEEE 802.11, dedicated short range communications (DSRC), cellular V2X (CV2X), and/or wide area networks (WAN), including the Internet, providing data communication services. For convenience, the label “V2X” is used herein for communications that may be vehicle-to-vehicle (V2V) and/or vehicle-to-infrastructure (V2I), and that may be provided by communication module 130 according to any suitable short-range communications mechanism, e.g., DSRC, cellular, or the like.

The network 135 represents one or more mechanisms by which a computer 110 may communicate with remote computing devices, e.g., the remote computer 140, another computer, etc. Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

A remote computer 140 is a computer that is external to a vehicle 105, and can communicate with the vehicle computer 110, e.g., to provide and/or request data for various vehicle components 125. Communications between the remote computer 140 and the vehicle computer 110 can be secured by authenticating the computers 110, 140 via suitable message authentication techniques. The remote computer 140 can be a conventional computing device, i.e., including one or more processors and one or more memories, programmed to provide operations such as disclosed herein. The remote computer 140 may be, e.g., a cloud-based server. As another example, the remote computer 140 may be a portable device, i.e., a computer that can be used while carried by a person, such as a smartphone, a tablet, a personal digital assistant, a smart watch, etc. Further, the remote computer 140 can be accessed via the network 135, e.g., the Internet, a cellular network, and/or or some other wide area network.

The computer 110 may be programmed to authenticate one or more ECUs 126 based on a security code 235. A security code 235 is a predetermined set of alphanumeric characters. The security code 235 may be stored, e.g., in a memory of the computer 110. The computer 110 may generate the security code 235, as discussed below. As another example, the remote computer 140 may generate the security code 235 and provide the security code 235 to the computer 110, e.g., via the network 135.

The computer 110 can authenticate the ECU 126 using suitable, e.g., conventional, message authentication techniques, e.g., public-key encryption, messaging roll code, message authentication code, etc. For example, the computer 110 can generate a message authentication code by inputting the security code 235 into a conventional cryptographic program than outputs the message authentication code. The computer 110 can then generate an authentication message 200, including the message authentication code. As another example, the computer 110 can generate the authentication message 200 by encrypting data based on the security code 235, e.g., using known encryption techniques. In such an example, the computer 110 can decrypt response messages 220 based on the security code 235, e.g., using known decryption techniques.

An authentication message 200 includes a header 201 and a payload 202 (see FIG. 2A). The header 201 of the authentication message 200 may include a message type, a message size, an identifier of the computer 110, etc. The payload 202 may include various data, i.e., message content. The payload 202 can include sub-payloads or payload segments 203-1, 203-2, 203-3 (collectively, referred to as payload segments 203). The respective payload segments 203 in FIG. 2A are illustrated as being of different lengths to reflect that different payload segments 203 may include various amount of data, and therefore may be of different sizes, i.e., lengths. For example, the computer 110 can include the message authentication code (or the encrypted data) in the payload 202, e.g., a specified payload segment 203, of the authentication message 200.

Upon generating the authentication message 200, the computer 110 can provide the authentication message 200 to one or more ECUs 126. For example, the computer 110 can transmit the authentication message 200 to an ECU 126 via the vehicle network. Upon receiving, from the ECU 126, a response message 220, the computer 110 can authenticate the ECU 126 based on the response message 220. For example, the computer 110 can authenticate the ECU 126 based on a received message authentication code included in the response message 220 matching the provided message authentication code. As another example, the computer 110 can decrypt the response message 220 based on the security code 235. In such an example, the computer 110 can authenticate the ECU 126 based on the decrypted data matching the provided data. Additionally, or alternatively, the remote computer 140 may be programmed to authenticate the computer 110, e.g., in substantially the same manner as discussed immediately above.

Upon authenticating the ECU 126, the computer 110 is programmed to determine whether a trigger event has occurred. For the purposes of this disclosure, a “trigger event” is defined as a specific condition that can be true or false at a given time. For example, a trigger event may be determined based on a power draw from a vehicle 105 battery being below a threshold. The computer 110 can determine the power draw from the vehicle 105 battery based on sensor 115 data. For example, the computer 110 can receive data from various sensors 115 indicating an amount of current flowing from the battery and an amount of voltage of the battery. The computer 110 can then determine the power draw based on the current and the voltage, e.g., using known calculation methods. Upon determining the power draw from the vehicle 105 battery, the computer 110 can compare the power draw to the threshold. The threshold specifies a power draw from the vehicle 105 battery below which the computer 110 determines a trigger event. The threshold may be stored, e.g., in a memory of the computer 110. The threshold may be determined empirically, e.g., based on testing that allows for determining a minimum power draw from the vehicle 105 battery in various vehicle 105 states, e.g., on, off, etc., and/or during various vehicle 105 operations. If the power draw from the vehicle 105 battery is equal to or greater than the threshold, then the computer 110 can be programmed to not determine a trigger event. If the power draw from the vehicle 105 battery is less than the threshold, then the computer 110 can be programmed to determine a trigger event.

A vehicle 105 battery provides electricity to one or more vehicle components 125. The power draw, i.e., the rate of power consumption, from the vehicle 105 battery varies based on a number of vehicle components 125 that consume electrical power. For example, when the vehicle 105 is in an on state, i.e., powered on, the vehicle 105 battery may provide electricity to all of the vehicle components 125. Alternatively, when the vehicle 105 is in an off state, i.e., powered off, the vehicle 105 battery may not provide electricity to all of the vehicle components 125. In a power-off state, the vehicle 105 battery may, for example, provide power to a subset, i.e., some but not all, of the vehicle components 125, or the vehicle 105 battery may not provide power to any of the vehicle components 125.

As another example, the computer 110 can determine a trigger event based on expiration of a timer. A duration of the timer is a predetermined time, e.g., 1 minute, 1 hour, 1 day, 1 week, etc. The duration of the timer may be stored, e.g., in the memory of the computer 110. The computer 110 can initiate the timer upon being initialized, i.e., flashed. When the timer expires, the computer 110 determines a trigger event. Upon expiration of the timer, the computer 110 can reset and initiate the timer.

Other non-limiting examples of trigger events can include the computer 110 receiving updated programming instructions via the network 135, the computer 110 detecting diagnostic fault codes, the computer 110 transitioning to an automated driving mode, the vehicle 105 transitioning from an off state to an on state, the computer 110 enabling a Passive Entry/Passive Start state, the computer 110 detecting unknown message on the vehicle communication network, the computer 110 not verifying another ECU 126, etc.

Additionally, or alternatively, the remote computer 140 may be programmed to determine whether a trigger event has occurred, e.g., in substantially the same manner as discussed immediately above.

Upon determining the trigger event, the computer 110 is programmed to verify the authenticated ECU(s) 126. To verify an authenticated ECU 126, the computer 110 generates a challenge message 205. Similar to the authentication message 200, a challenge message 205 includes a header 206 and a payload 207 (see FIG. 2B). The header 206 of the challenge message 205 may include a message type, a message size, an identifier of the computer 110, etc. The payload 207 may include various data, i.e., message content. Upon encrypting the security code 235, the computer 110 can include the encrypted security code 235 in the payload 207, e.g., a specified payload segment 208, of the challenge message 205.

To encrypt the security code 235, the computer 110 can, for example, input the security code 235 and an authentication key 245 to a permutation program 240 (See FIG. 2C). The permutation program 240 (sometimes called a permutation generator) can be a conventional cryptographic program, e.g., a program including an Advanced Encryption Standard (AES) algorithm. The permutation program 240 can rearrange the data in the security code 235 in an order that is specified by the authentication key 245. That is, the permutation program 240 performs, for each portion of the security code 235, one or more of a substitution, a change of order of segments in the message, or a mathematical operation according to block ciphers generated from the authentication key 245. For example, if the permutation program 240 is an AES algorithm, the computer 110 can identify a 16-bit portion of the security code 235, apply an “exclusive-or” function (i.e., an XOR function) between the 16-bit portion and a portion of the authentication key 245 to generate a first round string, and arrange first round string into a 4×4 grid. Then, the computer 110 can perform one of (1) shift respective positions of bits within the rows of the 4×4 grid, (2) substitute one of the bits in the 4×4 grid with a known substitution bit, (3) shift respective positions of bits within the columns of the 4×4 grid, or (4) scaling values of the bits by predetermined integers. The shifting, scaling, and substitution algorithms are determined according to the specific permutation program 240. The computer 110 can perform the permutation program 240 for the security code 235 to encrypt the security code 235.

The computer 110 can retrieve the authentication key 245, e.g., from the memory of the computer 110. The authentication key 245 is a predetermined set of alphanumeric characters. For example, the authentication key 245 can be a cryptographic key used in a conventional cryptographic program, e.g., Diffie-Hillman exchange, RSA encryption, AES, etc. The authentication key 245 can be specified, e.g., by a manufacturer of the computer 110. The computer 110 can receive the authentication key 245 from the remote computer 140, e.g., via the network 135.

As another example, the encrypted security code 235 may be a hash. A “hash” is an output of a “hash” function that outputs a unique string of alphanumeric bits for a specific input. That is, while the hash appears random, only the specific input can produce the specific hash. In such an example, the computer 110 can input the security code 235 into a cryptographic hash function as Secure Hash Algorithm 1 (SHA-1), to generate the hash (i.e., an encrypted bit string of a fixed size).

The computer 110 can provide the challenge message 205 to an authenticated ECU 126. For example, the computer 110 can transmit the challenge message 205 to the authenticated ECU 126 via the vehicle communication network. The ECU 126 can provide a reply message 225 in response to the challenge message 205, as discussed below.

In the example in which the remote computer 140 determines the trigger event, the remote computer 140 may be programmed to verify the computer 110. For example, the remote computer 140 can generate a challenge message 205, e.g., in substantially the same manner as discussed immediately above. The remote computer 140 can then provide the challenge message 205 to the computer 110. For example, the remote computer 140 can transmit the challenge message 205 to the computer 110 via the network 135. The computer 110 can provide a reply message 225 in response to the challenge message 205, as discussed below.

The computer 110 can receive a reply message 225 from the authenticated ECU 126 in response to the challenge message 205. The reply message 225 includes, e.g., in a specified payload segment 228, a security code 235 provided by the authenticated ECU 126. The computer 110 is programmed to identify the security code 235 provided by the authenticated ECU 126, e.g., based on the specified payload segment 228 of the reply message 225. For example, upon receiving a reply message 225 from the authenticated ECU 126, the computer 110 can access the specified payload segment 228 and retrieve the security code 235 provided by the authenticated ECU 126.

The retrieved security code 235 may be encrypted, e.g., based on the authentication key 245. For example, the retrieved security code 235 may be encrypted using the permutation program 240, as discussed above. In such an example, the computer 110 can decrypt the retrieved security code 235 based on the authentication key 245. That is, the computer 110 can rearrange the retrieved security code 235 to decrypt and recover the security code 235 by using the authentication key 245. As another example, the retrieved security code 235 may be a hash, as discussed above. In such an example, the computer 110 can rearrange the hash to re-compute the security code 235 by using the hash function and the authentication key 245.

The computer 110 can compare the retrieved security code 235 to the security code 235 provided in the challenge message 205. If the retrieved security code 235 matches the provided security code 235, then the computer 110 can verify the authenticated ECU 126. If the retrieved security code 235 does not match the provided security code 235, then the computer 110 is programmed to not verify the authenticated ECU 126. In such an example, the computer 110 can prevent communication with and/or ignore messages from the unverified ECU 126. Additionally, or alternatively, the computer 110 can provide a message to the remote computer 140, e.g., via the network 135, identifying the unverified ECU 126. In this situation, the computer 110 can access a header 226 of the reply message 225 and retrieve an identifier of the unverified ECU 126.

In the example in which the remote computer 140 provides a challenge message 205 to the computer 110, the remote computer 140 can verify the computer 110 based on a reply message 225 including the security code 235, e.g., in substantially the same manner as discussed immediately above.

Upon verifying the ECU 126, the computer 110 is programmed to update the security code 235. The computer 110 can, for example, update the security code 235 based on output from a random number generator. A “random number generator” is an algorithm that generates a sequence of numbers when seeded with an initial value. That is, the random number generator (RNG) is a deterministic algorithm that generates a specified sequence for each initial seed number; in the context of the present document, references to a random number generator are to what is understood in the computer 110 arts as a “pseudo-random number generator,” i.e., a number generator that generates a sequence of numbers based on an initial seed number. Said differently, the computer 110 can generate a sequence of random (or pseudorandom) numbers based on the initial seed number by using the RNG. The RNG can be a conventional algorithm, e.g., a Lehmer generator, a Mersenne Twister, an Advanced Randomization System, Philox, etc. In this document, “seed” has its conventional meaning in the computer 110 arts, i.e., in the present context, to “seed” means specifying an initial condition of the RNG algorithm, which initializes the random number generator to generate a specific sequence of numbers based on the specific initial condition, i.e., seed value.

The computer 110 can, for example, input the security code 235 into the random number generator as the seed value. As another example, the computer 110 can input a current time into the random number generator as the seed value. The computer 110 can store, e.g., in a memory of the computer 110, the random number as an updated security code 235. In the example in which the remote computer 140 verifies the computer 110, the remote computer 140 can update the security code 235, e.g., in substantially the same manner as discussed above.

Additionally, or alternatively, the computer 110 may associate some of the trigger events with ECU 126 verification and the remaining trigger events with security code 235 updates. For example, the computer 110 may maintain a look-up table or the like, e.g., stored in a memory of the computer 110, associating various trigger events with ECU 126 verification or security code 235 updates. In this situation, the computer 110 can be programmed to update the security code 235 upon detecting a trigger event associated with security code 235 updates, e.g., in the look-up table. That is, in some instances, the computer 110 can update the security code 235 prior to verifying the ECUs 126. As one example, a trigger event associated with ECU 126 verification may be expiration of a timer having a first duration, and a trigger event associated with security code 235 updates may be expiration of a timer having a second duration that is different, e.g., shorter, than the first duration. As another example, a trigger event associated with ECU 126 verification may be detecting a diagnostic trouble code, and a trigger event associated with security code 235 updates may be determining not to verify another ECU 126.

Upon updating the security code 235, the computer 110 generates a security message 210. Similar to the authentication message 200, the security message 210 includes a header 211 and a payload 212, including payload segments 213 (see FIG. 2D). The header 211 of the security message 210 may include a message type, a message size, an identifier of the computer 110, etc. The payload 212 may include various data, i.e., message content. Upon encrypting the updated security code 235, the computer 110 can include the encrypted updated security code 235 in the payload 212, e.g., a specified payload segment 213, of the security message 210. The computer 110 can encrypt the updated security code 235 based on a second authentication key 246, e.g., in substantially the same manner as discussed above regarding encrypting the security code 235.

The computer 110 can retrieve the second authentication key 246, e.g., from the memory of the computer 110. The second authentication key 246 is a predetermined set of alphanumeric characters. The second authentication key 246 is different from the authentication key 245, i.e., a different predetermined set of alphanumeric characters (see FIG. 2C). For example, similar to the authentication key 245, the second authentication key 246 can be a cryptographic key used in a conventional cryptographic program, e.g., Diffie-Hillman exchange, RSA encryption, AES, etc. The second authentication key 246 can be specified, e.g., by a manufacturer of the computer 110. The computer 110 can receive the second authentication key 246 from the remote computer 140, e.g., via the network 135. Encrypting the updated security code 235 by using the second authentication key 246 can increase the entropy of the security message 210.

The computer 110 can provide the security message 210 to the verified ECU 126. For example, the computer 110 can transmit the security message 210 to the verified ECU 126 via the vehicle communication network.

In the example in which the remote computer 140 verifies the computer 110, the remote computer 140 may be programmed to provide the updated security code 235 to the computer 110. For example, the remote computer 140 can generate a security message 210, e.g., in substantially the same manner as discussed immediately above. The remote computer 140 can then provide the security message 210 to the computer 110. For example, the remote computer 140 can transmit the security message 210 to the computer 110 via the network 135.

Prior to detecting a second trigger event, the computer 110 can provide a request message 215 to the verified ECU 126. Similar to the authentication message 200, the request message 215 includes a header 216 and a payload 217, including payload segments 218 (see FIG. 2E). The header 216 of the request message 215 may include a message type, a message size, an identifier of the computer 110, etc. The payload 217 may include various data, i.e., message content. The computer 110 can include the updated security code 235 and a counter in the payload 217, e.g., a specified payload segment 218, of the request message 215. Additionally, the computer 110 can include a request for data in the payload 217, e.g., in another specified payload segment 218, of the request message 215.

The computer 110 can store the counter, e.g., in a memory of the computer 110. The computer 110 is programmed to increment the counter upon transmitting the request message 215. Upon incrementing the counter, the computer 110 overwrites, e.g., in the memory, the counter with the incremented counter. The counter indicates a number of messages transmitted since a previous trigger event.

The computer 110 can provide the request message 215 to the verified ECU 126. For example, the computer 110 can transmit the request message 215 to the verified ECU 126 via the vehicle communication network. The ECU 126 can provide a relay message 230 in response to the request message 215, as discussed below.

In the example in which the remote computer 140 verifies the computer 110, the remote computer 140 may be programmed to provide the request message 215 to the computer 110. For example, the remote computer 140 can generate the request message 215, e.g., in substantially the same manner as just described. The remote computer 140 can then provide the request message 215 to the computer 110. For example, the remote computer 140 can transmit the request message 215 to the computer 110 via the network 135. In such an example, the remote computer 140 can increment the counter upon transmitting the request message 215. That is, the remote computer 140 may store the counter, e.g., in a memory. The computer 110 can provide a relay message 230 in response to the request message 215, as discussed below.

Upon receiving the relay message 230, the computer 110 can authenticate the relay message 230 based on the updated security code 235 and the incremented counter. For example, the computer 110 can access the specified payload segment 233 of the relay message 230 and retrieve the updated security code 235 and the incremented counter. The computer 110 can then compare the retrieved security code 235 and the retrieved counter to the provided security code 235 and the incremented counter, respectively. If the retrieved security code 235 matches the provided security code 235 and the retrieved counter matches the incremented counter, then the computer 110 authenticates the relay message 230. If the retrieved security code 235 does not match the provided security code 235, or the retrieved counter does not match the incremented counter, then the computer 110 is programmed to not authenticate the relay message 230. In such an example, the computer 110 may ignore the relay message 230. Additionally, or alternatively, the computer 110 can provide a message to the remote computer 140, e.g., via the network 135, identifying the ECU 126 that transmitted the unauthenticated relay message 230. In this situation, the computer 110 can access a header 231 of the relay message 230 and retrieve an identifier of the ECU 126 that transmitted the relay message 230. Authenticating messages between triggering events based on the updated security code 235 and the counter can reduce the computational resources needed to authenticate the messages as compared to cryptographically authenticating each message, which can minimize a power draw from the vehicle 105 battery.

In the example in which the remote computer 140 provides the request message 215 to the computer 110, the remote computer 140 can authenticate a relay message 230 received from the computer 110, e.g., in substantially the same manner as discussed immediately above.

As set forth above, respective ECUs 126 can be programmed to monitor and/or operate one or more vehicle components 125. Additionally, respective ECUs 126 may be programmed to authenticate the computer 110 based on the security code 235. Each ECU 126 may store, e.g., in a respective memory, the security code 235. Each ECU 126 can, for example, receive the authentication message 200 from the computer 110, as discussed above. An ECU 126 can then authenticate the computer 110 based on the authentication message 200. For example, the ECU 126 can authenticate the computer 110 based on a received message authentication code included in the authentication matching a stored message authentication code, e.g., stored in a respective memory of the ECU 126. As another example, the ECU 126 can decrypt the authentication message 200 based on the security code 235. In such an example, the ECU 126 can authenticate the computer 110 based on the decrypted data matching the stored data, e.g., stored in a respective memory of the ECU 126. Upon failing to authenticate the computer 110, the ECU 126 can ignore messages from the computer 110. In the example in which the remote computer 140 provides the authentication message 200 to the computer 110, the computer 110 can be programmed to authenticate the remote computer 140, e.g., in substantially the same manner as just discussed.

Upon authenticating the computer 110, the ECU 126 can generate a response message 220. Similar to the authentication message 200, the response message 220 includes a header 221 and a payload 222, including payload segments 223 (see FIG. 2F). The header 221 of the response message 220 may include a message type, a message size, an identifier of the ECU 126, etc. The payload 222 may include various data, i.e., message content. The ECU 126 can include the message authentication code (or the encrypted data) in the payload 222, e.g., a specified payload segment 223, of the response message 220. The ECU 126 can then provide the response message 220 to the computer 110. For example, the ECU 126 can transmit the response message 220 to the computer 110 via the vehicle network.

In the example in which the computer 110 authenticates the remote computer 140, the computer 110 can be programmed to generate the response message 220, e.g., in substantially the same manner as discussed above. In such an example, the computer 110 can then provide the response message 220 to the remote computer 140. For example, the computer 110 can transmit the response message 220 to the remote computer 140 via the network 135.

Respective ECUs 126 can be programmed to verify the computer 110 based on the challenge message 205. An ECU 126 can receive the challenge message 205 from the computer 110, e.g., via the vehicle network, as discussed above. The ECUs 126 can identify the encrypted security code 235, e.g., based on a specified payload segment 208 of the challenge message 205. For example, upon receiving the challenge message 205 from the computer 110, the ECUs 126 can access the specified payload segment 208 and retrieve the encrypted security code 235.

Respective ECUs 126 can be programmed to then decrypt the retrieved security code 235 based on the authentication key 245, e.g., in substantially the same manner as discussed above regarding the computer 110 decrypting a retrieved security code 235. If the decrypted security code 235 matches the respective stored security code 235, then the ECUs 126 can verify the computer 110. If the decrypted security code 235 does not match the respective stored security codes 235, then the ECUs 126 are programmed to not verify the computer 110. In this situation, the ECUs 126 can ignore messages from the computer 110. Additionally, or alternatively, the ECUs 126 can provide a message to another computer in the vehicle 105, e.g., via the vehicle communication network, identifying the unverified computer 110. In this situation, the computer 110 can access a header 206 of the challenge message 205 and retrieve an identifier of the unverified computer 110.

In the example in which the remote computer 140 provides the challenge message 205 to the computer 110, the computer 110 can verify the remote computer 140, e.g., in substantially the same manner as discussed above.

Upon verifying the computer 110, the ECUs 126 can generate a reply message 225. Similar to the authentication message 200, the reply message 225 includes a header 226 and a payload 227 (see FIG. 2G). The header 226 of the reply message 225 may include a message type, a message size, an identifier of the computer 110, etc. The payload 227 may include various data, i.e., message content. Upon encrypting the security code 235, the ECUs 126 can include the encrypted security code 235 in the payload 227, e.g., a specified payload segment 228, of the respective reply message 225. The ECUs 126 can encrypt the security code 235 based on the authentication key 245, e.g., in substantially the same manner as discussed above with regard to the computer 110 encrypting the security code 235. The ECUs 126 can retrieve the authentication key 245, e.g., from a respective memory.

The ECUs 126 can provide the respective reply message 225 to the computer 110. For example, the ECUs 126 can transmit the respective reply message 225 to the computer 110 via the vehicle communication network. The computer 110 can provide a security message 210 in response to the reply message 225, as discussed above.

In the example in which the remote computer 140 provides the challenge message 205, the computer 110 may generate a reply message 225, e.g., in substantially the same manner as discussed immediately above. The computer 110 can provide the reply message 225 to the remote computer 140. For example, the computer 110 can transmit the reply message 225 to the remote computer 140 via the network 135. The remote computer 140 can provide a security message 210 in response to the reply message 225, as discussed above.

Respective ECUs 126 can be programmed to update the stored security code 235 based on the security message 210. The ECUs 126 can receive the security message 210 from the computer 110, e.g., via the vehicle network, as discussed above. The ECUs 126 can identify the updated security code 235, e.g., based on the specified payload segment 213 of the security message 210. For example, the ECUs 126 can access the specified payload segment 213 and retrieve the updated security code 235.

Respective ECUs 126 can be programmed to then decrypt the retrieved security code 235 based on the second authentication key 246, e.g., in substantially the same manner as discussed above regarding the computer 110 decrypting a retrieved security code 235. Respective ECUs 126 can be programmed to overwrite, e.g., in a respective memory, the stored security code 235 with the updated security code 235.

In the example in which the remote computer 140 provides the security message 210 to the computer 110, the computer 110 can update the stored security code 235, e.g., in substantially the same manner as discussed immediately above.

Respective ECUs 126 can be programmed to receive a request message 215 from the computer 110. The ECUs 126 are programmed to authenticate the request message 215 based on the updated security code 235 and the counter. The ECUs 126 can be programmed to identify the updated security code 235 and the counter, e.g., based on a specified payload segment 218 of the request message 215. For example, upon receiving the request message 215, an ECU 126 could access the specified payload segment 218 and retrieve the updated security code 235 and the counter. An ECU 126 can then compare the retrieved security code 235 and the retrieved counter to the stored security code 235 and the counter, respectively. If the retrieved security code 235 matches the stored security code 235 and the retrieved counter matches the counter, then the ECUs 126 authenticate the request message 215. If the retrieved security code 235 does not match the stored security code 235, or the retrieved counter does not match the counter, then the ECUs 126 are programmed to not authenticate the request message 215. In such an example, the ECUs 126 may ignore the request message 215. Additionally, or alternatively, the ECUs 126 can provide a message to another computer in the vehicle, e.g., via the vehicle communication network, identifying the computer 110 that transmitted the unauthenticated request message 215. In this situation, the ECUs can access a header 216 of the request message 215 and retrieve an identifier of the computer 110 that transmitted the request message 215.

An ECU 126 can store the counter in a respective memory. The ECUs 126 are programmed to increment the counter upon authenticating the request message 215. Upon incrementing the counter, the ECUs 126 overwrite, e.g., in the memory, the counter with the incremented counter.

Upon incrementing the counter, the ECUs 126 can generate respective relay messages 230. Similar to the authentication message 200, the relay message 230 includes a header 231 and a payload 232. (See FIG. 2H). The header 231 of the relay message 230 may include a message type, a message size, an identifier of the computer 110, etc. The payload 232 may include various data, i.e., message content. The ECUs 126 can include the updated security code 235 and the incremented counter in the payload 232, e.g., a specified payload segment 233, of the relay message 230. Additionally, the ECUs 126 can include the requested data in the payload 232, e.g., in another specified payload segment 233, of the relay message 230.

The ECUs 126 can provide the respective relay messages 230 to the computer 110. For example, the ECUs 126 can transmit the respective relay messages 230 to the computer 110 via the vehicle communication network.

In the example in which the remote computer 140 provides the request message 215 to the computer 110, the computer 110 can authenticate the request message 215, e.g., in substantially the same manner as discussed above. The computer 110 can then generate a relay message 230, e.g., in substantially the same manner as discussed above. The computer 110 can then provide the relay message 230 to the remote computer 140. For example, the computer 110 can transmit the relay message 230 to the remote computer 140 via the network 135.

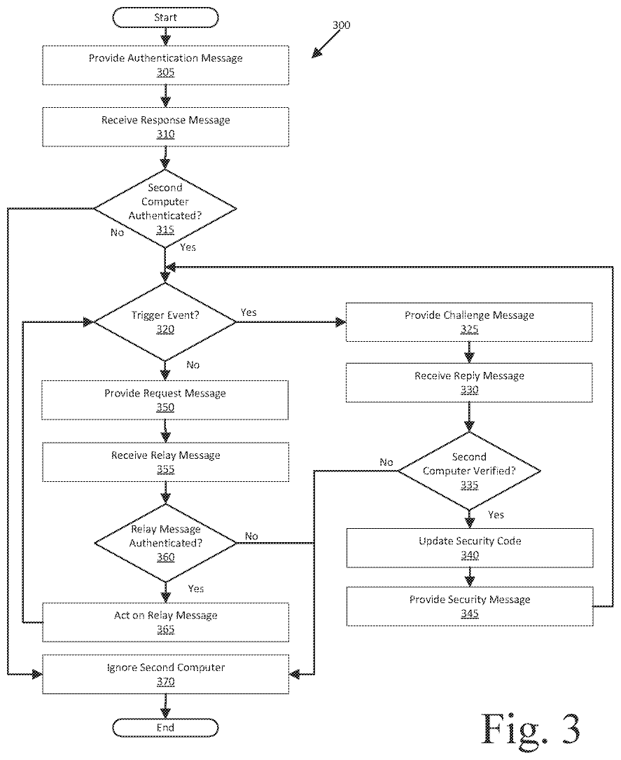

FIG. 3 is a diagram of an example process 300 executed in a first computer according to program instructions stored in a memory thereof for updating a security code 235 for a second computer. The first computer can be, for example, a computer 110 included in a vehicle 105. In such an example, the second computer can be an ECU 126 included in the vehicle 105. Alternatively, the first computer can be a remote computer 140. In such an example, the second computer can be the computer 110 included in the vehicle 105.

The process 300 begins in a block 305. In the block 305, the first computer provides an authentication message 200 to one or more second computers. The first computer generates the authentication message 200 based on a security code 235, as discussed above. Upon generating the authentication message 200, the first computer can transmit the authentication message 200 to the second computer, as discussed above. The process 300 continues in a block 310.

In the block 310, the first computer receives a response message 220 from the second computer. In an example in which the first computer provides the authentication message 200 to a plurality of second computers, the first computer receives a unique response message 220 from each of the plurality of second computers. The process 300 continues in a block 315.

In the block 315, the first computer determines whether to authenticate the second computer. The first computer can authenticate the second computer based on the security code 235 and the response message 220, as discussed above. If the first computer authenticates the second computer, then the process 300 continues in a block 320. Otherwise, the process 300 continues in a block 370.

In the block 320, the first computer determines whether a trigger event has occurred, as discussed above. As set forth above, a “trigger event” in the context of this document is a specific condition that can be true or false at a given time. If the first computer determines that a trigger event has occurred, the process 300 continues in a block 325. Otherwise, the process 300 continues in the block 350.

In the block 325, the first computer provides a challenge message 205 to the second computer. The first computer can generate the challenge message 205 by encrypting the security code 235 based on an authentication key 245 and including the encrypted security code 235 in the challenge message 205, as discussed above. The first computer can then transmit the challenge message 205 to the second computer, as discussed above. The process 300 continues in a block 330.

In the block 330, the first computer receives a reply message 225 from the second computer. In an example in which the first computer provides the challenge message 205 to a plurality of second computers, the first computer receives a unique reply message 225 from each of the plurality of second computers. The first computer can retrieve the encrypted security code 235 from the reply message 225, as discussed above. The first computer can then decrypt the retrieved encrypted security code 235 based on the authentication key 245, as discussed above. The process 300 continues in a block 335.

In the block 335, the first computer determines whether the second computer is verified. If the retrieved decrypted security code 235 matches the security code 235 provided in the challenge message 205, then the first computer verifies the second computer. If the retrieved decrypted security code 235 does not match the security code 235 provided in the challenge, then the first computer determines to not verify the second computer. Upon determining to not verify the second computer, the first computer can output a message identifying the unverified second computer, as discussed above. If the second computer is verified, then the process 300 continues in a block 340. Otherwise, the process 300 continues in the block 370.

In the block 340, the first computer updates the security code 235, e.g., based on output from a random number generator, as discussed above. The process 300 continues in a block 345.

In the block 345, the first computer provides a security message 210 to the second computer. The first computer can generate the security message 210 by encrypting the updated security code 235 based on a second authentication key 246 and including the encrypted updated security code 235 in the security message 210, as discussed above. The first computer can then transmit the security message 210 to the second computer, as discussed above. The process 300 returns to the block 320.

In the block 350, the first computer provides a request message 215 to the second computer. The first computer can include the updated security code 235 and a counter in the request message 215, as discussed above. The first computer can then transmit the request message 215 to the second computer, as discussed above. Upon transmitted the request message 215, the first computer can increment the counter, as discussed above. The process 300 continues in a block 355.

In the block 355, the first computer receives a relay message 230 from the second computer. In an example in which the first computer provides the challenge message 205 to a plurality of second computers, the first computer receives a unique relay message 230 from each of the plurality of second computers. The first computer can retrieve the updated security code 235 and the incremented counter from the relay message 230, as discussed above. The process 300 continues in a block 360.

In the block 360, the first computer determines whether to authenticate the relay message 230. If the retrieved updated security code 235 and the retrieved incremented counter match the updated security code 235 provided in the request message 215 and the stored incremented counter, respectively, then the first computer authenticates the relay message 230. If the retrieved updated security code 235 does not match the updated security code 235 provided in the request message 215 or the retrieved incremented counter does not match the stored incremented counter, then the first computer determines to not authenticate the relay message 230. Upon determining not to authenticate the relay message 230, the first computer can output a message identifying the second computer that transmitted the unauthenticated relay message 230, as discussed above. If the relay message 230 is authenticated, then the process 300 continues in a block 365. If the relay message 230 is not authenticated, then the process 300 continues in the block 370.

In the block 365, the first computer acts on the relay message 230. For example, the first computer may operate the vehicle 105, e.g., actuate one or more vehicle components, based on the relay message 230. As another example, the first computer may store, e.g., in a memory of the first computer, data included in the relay message 230. The process 300 returns to the block 320.

In the block 370, the first computer ignores the second computer. That is, the first computer determines not to store or act on data received from the second computer. The process 300 ends following the block 370.

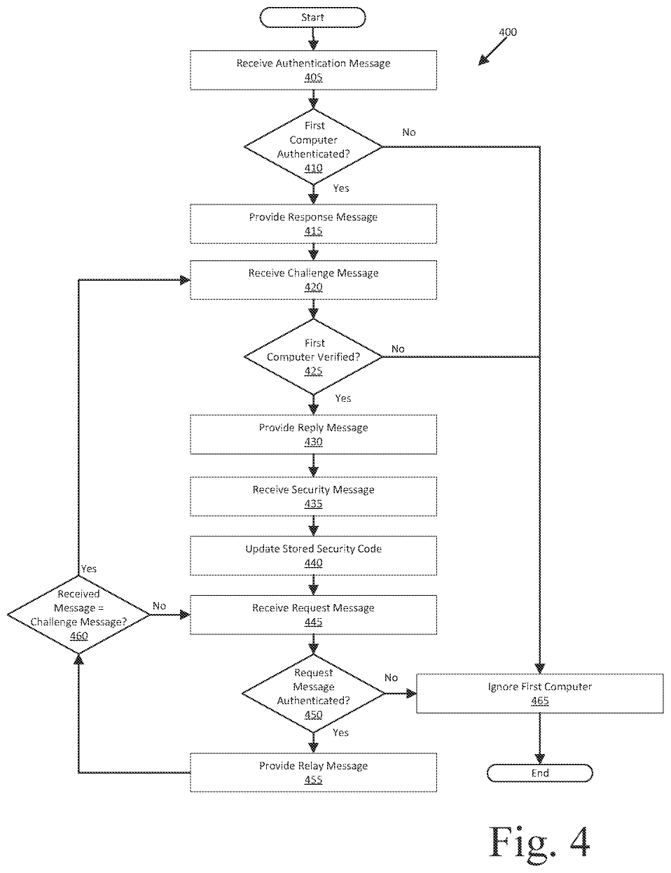

FIG. 4 is a diagram of an example process 400 executed in a second computer according to program instructions stored in a memory thereof for updating a security code 235 in the second computer. The second computer can be, for example, an ECU 126 included in the vehicle 105 when the first computer is the computer 110 included in the vehicle 105. Alternatively, the second computer can be the computer 110 included in the vehicle 105 when the first computer is the remote computer 140.

The process 400 begins in a block 405. In the block 405, the second computer receives the authentication message 200 from the first computer. The process 400 continues in a block 410.

In the block 410, the second computer determines whether to authenticate the first computer. The second computer can authenticate the first computer based on the security code 235 and the authentication message 200, as discussed above. If the second computer authenticates the first computer, then the process 400 continues in a block 415. Otherwise, the process 400 continues in a block 465.

In the block 415, the second computer provides a response message 220 to the first computer. The second computer generates the response message 220 based on a security code 235, as discussed above. Upon generating the response message 220, the second computer can transmit the response message 220 to the first computer, as discussed above. The process 400 continues in a block 420.

In the block 420, the second computer receives the challenge message 205 from the first computer. The second computer can retrieve the encrypted security code 235 from the challenge message 205, as discussed above. The second computer can then decrypt the retrieved encrypted security code 235 based on the authentication key 245, as discussed above. The process 400 continues in a block 425.

In the block 425, the second computer determines whether the first computer is verified. If the retrieved decrypted security code 235 matches the security code 235 stored by the second computer, e.g., in a memory of the second computer, then the second computer verifies the first computer. If the retrieved decrypted security code 235 does not match the stored security code 235, then the second computer determines to not verify the first computer. Upon determining not to verify the first computer, the second computer can output a message identifying the unverified first computer, as discussed above. If the first computer is verified, then the process 400 continues in a block 430. Otherwise, the process 400 continues in the block 465.

In the block 430, the second computer provides a reply message 225 to the first computer. The second computer generates the reply message 225 by encrypting the security code 235 based on an authentication key 245 and including the encrypted security code 235 in the reply message 225, as discussed above. The second computer can then transmit the reply message 225 to the first computer, as discussed above. The process 400 continues in a block 435.

In the block 435, the second computer receives the security message 210 from the first computer. The second computer can retrieve the encrypted updated security code 235 from the security message 210, as discussed above. The second computer can then decrypt the retrieved encrypted updated security code 235 based on the second authentication key 246, as discussed above. The process 400 continues in a block 440.

In the block 440, the second computer updates the security code 235 stored in the memory of the second computer. For example, the second computer can overwrite the security code 235 with the updated security code 235, as discussed above. The process 400 continues in a block 445.

In the block 445, the second computer receives the request message 215 from the first computer. The second computer can retrieve the updated security code 235 and the counter from the request message 215, as discussed above. The process 400 continues in a block 450.

In the block 450, the first computer determines whether to authenticate the relay message 230. If the retrieved updated security code 235 and the retrieved incremented counter match the updated security code 235 provided in the request message 215 and the stored incremented counter, respectively, then the first computer authenticates the relay message 230. If the retrieved updated security code 235 does not match the updated security code 235 provided in the request message 215 or the retrieved incremented counter does not match the stored incremented counter, then the first computer determines to not authenticate the relay message 230. Upon determining not to authenticate the request message 215, the second computer can output a message identifying the first computer that transmitted the unauthenticated request message 215, as discussed above. If the relay message 230 is authenticated, then the process 300 continues in a block 365. If the relay message 230 is not authenticated, then the process 300 continues in the block 370.

In the block 455, the second computer provides the relay message 230 to the first computer. The second computer can include the updated security code 235 and the incremented counter in the relay message 230, as discussed above. The second computer can then transmit the relay message 230 to the first computer, as discussed above. The process 400 continues in a block 460.

In the block 460, the second computer determines whether a subsequently received message is a challenge message 205. For example, the second computer can access a header of the subsequently received message and can retrieve a message type from the header. If the message type indicates that the subsequently received message is a challenge message 205, then the process 400 returns to the block 420. Otherwise, the process 400 returns to the block 445.

In the block 465, the second computer ignores the first computer. That is, the second computer determines not to store or act on data received from the first computer. The process 400 ends following the block 465.

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board first computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system, comprising:
a first computer including a processor and a memory, the memory storing instructions executable by the processor such that the first computer is programmed to:
in response to a trigger event, generate a challenge message that includes a security code by inputting the security code to a cryptographic program that encrypts the security code based on an authentication key;
upon transmitting the challenge message to a second computer, update the security code based on a random number output from a random number generator;
receive a reply message from the second computer in response to the challenge message; and
upon verifying the second computer based on the reply message, transmit a security message including the updated security code to the second computer.

2. The system of claim 1, wherein the first computer is further programmed to generate the security message by inputting the updated security code to a cryptographic program that encrypts the security code based on a second authentication key.

3. The system of claim 2, further comprising the second computer, including a second processor and a second memory storing instructions executable by the second processor such that the second computer is programmed to input the encrypted updated security code to a cryptographic program that decrypts the encrypted updated security code based on the second authentication key.

4. The system of claim 1, further comprising the second computer, including a second processor and a second memory storing instructions executable by the second processor such that the second computer is programmed to:
input the encrypted security code to a cryptographic program that decrypts the encrypted security code based on the authentication key; and
transmit the reply message including the security code in response to the challenge message.

5. The system of claim 1, further comprising the second computer, including a second processor and a second memory storing instructions executable by the second processor such that the second computer is programmed to:
upon receiving the challenge message, verify the first computer based on the security code matching a stored security code; and
then transmit the reply message including the stored security code.

6. The system of claim 5, wherein the first computer is further programmed to, upon receiving the reply message, verify the second computer based on the stored security code matching the security code.

7. The system of claim 1, wherein the first computer is further programmed to:
prior to detecting a second trigger event, transmit a request message to the second computer including the updated security code and a counter; and
then increment the counter stored in a respective memory.

8. The system of claim 7, wherein the first computer is further programmed to authenticate a relay message from the second computer based on the relay message including the updated security code and the incremented counter in response to the request message.

9. The system of claim 7, further comprising the second computer, including a second processor and a second memory storing instructions executable by the second processor such that the second computer is programmed to:
authenticate the request message from the first computer based on the request message including the updated security code and the counter;
increment the counter stored in a respective memory;
transmit a relay message including the updated security code and the incremented counter.

10. The system of claim 1, further comprising the second computer, including a second processor and a second memory storing instructions executable by the second processor such that the second computer is programmed to update a stored security code in response to the security message.

11. The system of claim 1, wherein the trigger event is determined based on a power draw from a vehicle battery being below a threshold.

12. The system of claim 1, wherein the trigger event is expiration of a timer.

13. The system of claim 1, wherein the first computer and the second computer are included in a vehicle.

14. The system of claim 1, wherein the first computer is remote from a vehicle and the second computer is included in the vehicle.

15. A method, comprising:
in response to a trigger event, generating, at a first computer, a challenge message that includes a security code by inputting the security code to a cryptographic program that encrypts the security code based on an authentication key;
upon transmitting the challenge message to a second computer, updating the security code based on a random number output from a random number generator;
receiving a reply message from the second computer in response to the challenge message; and
upon verifying the second computer based on the response, transmitting a security message including the updated security code to the second computer.

16. The method of claim 15, further comprising generating the security message by inputting the updated security code to a cryptographic program that encrypts the security code based on a second authentication key.

17. The method of claim 15, further comprising:
prior to detecting a second trigger event, transmitting a request message to the second computer including the updated security code and a counter; and
then incrementing the counter stored in a respective memory.

18. The method of claim 17, further comprising authenticating a relay message from the second computer based on the relay message including the updated security code and the incremented counter in response to the request message.

19. The method of claim 15, wherein the trigger event is determined based on a power draw from a vehicle battery being below a threshold.

20. The method of claim 15, wherein the trigger event is expiration of a timer.
